(19) United States
(12) Patent Application Publication
(10) Pub. No.: US 2003/0084117 A1
(43) Pub. Date: May 1, 2003

(54) Device, system, computer program product, data repository, and a client communication device for processing information items related to one of a bearing, a seal, and a product including one of a bearing and a seal and applications

(76) Inventors: Linda Widbro, Goteborg (SE); Anders Sahlgren, Molndal (SE); Magnus Olsson, Molndal (SE); Hubert Kottritsch, Amstetten (AT)

Correspondence Address: Ronald L. Grudziecki, BURNS, DOANE, SWECKER & MATHIS, L.L.P., P.O. Box 1404, Alexandria, VA, 22313-1404, US

(21) Appl. No.: 10/253,536

(22) Filed: Sep. 25, 2002

(30) Foreign Application Priority Data
Sep. 26, 2001 (SE) 0103244-0

(51) Int. Cl. G06F 15/16; G06F 7/00; G06F 17/60; G06F 17/30

(52) U.S. Cl. 709/217; 707/10; 705/29

(57) ABSTRACT

Device, system, computer program product, data repository, and a client communication device for processing information items related to one of a bearing, a seal, and a product including one of a bearing and a seal and applications is provided. An information item database includes information items. Each information item is one of journal data item and individual unit data item. Each individual unit data item includes an individual unit identity of an individual unit and at least one of text and image. Each individual data item also includes at least one link linking at least one journal data item related to the individual unit data item to the individual unit data item. Each journal data item includes at least one of text, image, symbol and binary data. The device can be used to trace individual units.

This application is based on and claims priority under 35 U.S.C. § 119 with respect to Swedish Application No. 0103244-0 filed on Sept. 26, 2001, the entire content of which is incorporated herein by reference.

### FIELD OF THE INVENTION

The present invention relates to a device, a system, a computer program product, a data repository, and a client communication device for processing information items related to one of an individual unit and an application of an individual unit, where the individual unit is one of a bearing, a seal, and a product including one of a bearing and a seal.

### BACKGROUND OF INVENTION

The progress in the fields of computers and communications have reached a point where they now can offer increased competitive advantages for companies also within more mature technical fields, such as bearings and seals.

During the last decade the knowledge necessary to handle and use products has increased in several technical fields. One of these technical fields relates to bearings and seals. Even though the basic principles of today's bearings and seals in some cases are almost 100 years old, the requirements of these products have increased, for instance, in terms of functionality and reliability. The increased requirements on bearings, seals and products incorporating bearings or seals places requirements, for instance, on how it is used, serviced and maintained. Accordingly, there is an increased need for information related to individual bearings, seals and products incorporating bearings and seals. Currently there are only limited opportunities for interacting with information concerning bearings, seals and their application.

### SUMMARY OF INVENTION

The present invention is directed to the processing of information items related to one of an individual unit and an application of an individual unit. The individual unit is one of a bearing, a seal, and a product including one of a bearing and a seal.

Exemplary embodiments of the present invention relate to a device, a client communication device, a system, a computer program product, and a data repository for processing information items related to one of an individual unit and an application of an individual unit, the individual unit being one of a bearing, a seal, and a product including one of a bearing and a seal. The present invention also relates to use of such a device to trace individual units.

The aspects above are based on the following features. The features cover, from different technical aspects, an information item database comprising information items, where each information item is one of journal data item and individual unit data item. Each individual unit data item comprises an individual unit identity of an individual unit, at least one of text and image, and at least one link linking at least one journal data item related to the individual data item to the individual data item. Each journal data item comprises at least one of text, image, symbol and binary data. The information item database is operated by a computer processor.

A first advantage of using the information item database is the secure and reliable way of handling information concerning an individual unit, an individual unit being one of a bearing, a seal, and a product including one of a bearing and a seal.

A second advantage of using the information item database is the secure and reliable way of handling information concerning the application of an individual unit. Here the term application should be interpreted as a designation or use of an individual unit.

A third advantage is that the information item database also assists a user of one of an individual unit and its application in providing information of activities related thereto. For instance, in the information item database a user can find information concerning the latest service occasion, such as when it was performed and comments of the person/persons having performed it. Information of this kind may play an important role in guarantee commitments.

A fourth advantage is that the information item database also assists a user of one of an individual unit and its application, in providing detailed static information of the individual unit. For instance, in the information item database a user can find information concerning the actual dimensions, clearance, lubrication type, type of cage, preferred sealing, and the measuring protocol of the individual unit.

Also, for instance, information of more generic character, such as information concerning a type, or family, to which an individual unit belongs, compared to information concerning a specific individual item can be provided. Further, information concerning, e.g., processes of manufacturing, testing, distributing, mounting, using, servicing, maintaining, and dismounting the individual unit is comprised in the individual unit data item. Thus, an individual unit data item comprises information that is specifically related to an individual unit but also information which is applicable for other individual units.

An advantage of having the two types of information items, static-oriented and journal-oriented, is that these two types of structural elements increase the performance of the information item database to handle two types of information. Each information item being one of journal data item and individual unit data item increase a user's or a service provider's control of the information item database.

An advantage of each individual unit data item comprising an individual unit identity of an individual unit is that the contents of the individual unit data item type is limited to information concerning the individual unit. This increases the opportunity of perceiving an individual item as an individual, since an individual unit data item comprises data of an individual unit.

An advantage of having individual unit data item of at least one of text and image is that the utility of the information item database increases due to the possibility of handling up to two types of information. It should be pointed out that the text here also includes numbers.

An advantage of having at least one link linking at least one journal data item related to the individual data item to the individual data item is that the opportunities of searching and finding one or more journal data items related to a specific individual increases.

An advantage of having each journal data item comprising at least one of text, image, symbol and binary data is that the utility of the information item database increases due to the possibility of handling up to these four types of information types.

Thus, a key notion of the present invention is that an individual unit or its application is perceived as an individual.

According to the first aspect above, the device comprises a processor, a memory, and an input/output connection. The memory comprises the information item database as described above. The processor is configured for receiving at least one information item from a user using the input/output connection. If the information item is a journal data item, the processor also receives a link to the individual unit data item in the information item database related to the journal data item. The processor stores the at least one information item in the information item database. If the information item is a journal data item, then the processor links it to the individual unit data item according to the link. The processor receives at least one request from the user requesting an information item. The processor retrieves from the information item database of the memory and transmits the at least one requested information item to the user using the input/output connection.

An advantage of this aspect is that the device offers increased opportunities for a service provider, or a producer of individual units to fulfil customer needs in relation to individual units.

According to a second aspect a client communication device comprises a processor, a memory, and an input/output connection. The processor adds information to at least one information item. Using the input/output connection the processor transmits at least one information item from a user to the device for processing information items. If the information item is a journal data item, the processor also transmits a link to the individual unit data item related to the journal data item. The processor transmits at least one request from the user requesting an information item and receives the at least one requested information item from the device for processing information items.

An advantage of this aspect is that the client communication device offers increased opportunities for a customer of a producer of individual units to fulfil its needs in relation to access to information concerning individual units.

According to a third aspect, a system for processing information items related to at least one individual unit, in which the individual unit is one of a bearing, a seal, and a product including one of a bearing and a seal is provided. The system comprises a device according to the first aspect and a client device according to the second aspect. The system offers the advantage of providing an information technology infrastructure that process information items. The presence of this infrastructure leads to an opportunity of having control over individual units and their applications, which decrease, for instance, the probability of individual unit malfunction.

According to a fourth aspect, a computer program product, which is loadable into the internal memory of a computer, comprises software code portions for performing the same procedures in relation to an information item database when run on the computer. This aspect covers the computer programs involved in the device according to the first aspect. The advantages are the same as the advantages of the information item database and the device according to the first aspect.

According to a fifth aspect, a data repository comprises the computer program product, which comprises the information item database as described above. The advantages are the same as the advantages of the information item database. According to another preferred embodiment, the data repository is incorporated in a memory.

According to a preferred embodiment of the device, the client communication device, the computer program product and data repository, the journal data items are related to at least one point of time in relation to at least one of the processes of manufacturing, testing, distributing, mounting, using, servicing, maintaining, and dismounting the individual unit. Generally, the term servicing is here considered to include refurbishing and lubricating. It should be noted that inputting point of time is not mandatory. For example, in the manufacturing process of an individual unit, the points of time may not be inputted. However, inputting points of time offers the advantage of being able to show information concerning at what time a specific process was undertaken in relation to an individual item. In the case of an application of an individual unit, the information may deal with what type of individual unit that was applied prior to substituting that individual unit.

According to another preferred embodiment of the device, the client communication device, and the computer program product, the individual unit data item further comprises at least one of actual dimensions, clearance, lubrication type, type of cage, preferred sealing, and the measuring protocol of the individual unit, and information concerning at least one of manufacturing, testing, distributing, mounting, using, servicing, maintaining, and dismounting the individual unit. For the device, the client communication device and the computer program product this offers the advantage of users having higher requirements concerning these parameters to request an individual unit having actual dimensions fulfilling the requirements. Also it offers the advantage of the user to obtain information of more generic character. For the client communication device this also offers the opportunity of a user having a possibility of obtaining information concerning individual units or their application.

According to another preferred embodiment of the device, the client communication device, and the computer program product, each journal data item is provided with a link linking the journal data item to an individual unit data item. This offers the advantage of searching and finding, also known as tracing, individual units or applications of individual units. From the aspect of the client communication device, the tracing abilities are less abundant compared to the tracing abilities of the device according to the first aspect.

According to another preferred embodiment of the device, the input/output connection of the device is connectable to at least one of a data communication network, such as the internet, a movable media, and an input/output means of a computer. This increases the possibilities of using the device with a standard computer and communication environment.

According to another preferred embodiment of the device and the client communication device, the processor is further configured for creating new information items. This facilitates for a user or a service provider to increase the utility of the device since new individual units or applications of individual units can be defined within the information item database.

According to another preferred embodiment of the device, the processor is further configured for deleting information items. This facilitates for a user or a service provider to increase the utility of the device since no longer needed or unwanted individual units or applications of individual units can be removed from the information item database.

According to another preferred embodiment of the device, the information items are configured with access levels and the processor is configured for verifying a user in relation to the access levels. The access levels control rights of a user and a staff of the service provider to create a new information item, delete an information item, add information to an information item, change information of an information item, and remove information of an information item. This offers increased opportunities of controlling the security of the access to the information item database.

According to a sixth aspect, the device according to the first aspect can trace individual units is based on searching the information item database comprising the information items.

One purpose of tracing is to determine the cause of poor quality in relation to processes of manufacturing. Also, tracing can be used to locate other individual units being related to a specific individual unit, for instance for finding individual units of the same batch. A trace can provide important information when it comes to finding explanations to e.g. unexpected malfunctions. Thus, a tracing facility provides an instrument of the quality work of the manufacturing. Tracing can explain causes of extraordinary events, such as malfunctions.

According to a first embodiment of the tracing aspect, the tracing is performed by entering one or more individual unit data items resulting in one or more traces. The traces will inform a user of what events an individual unit has been subjected to. In the information item database this is achieved by searching for one or more individual unit identities among the individual unit data items to find out what events that may have caused an extraordinary effect on an individual unit. However, in an alternative embodiment the individual unit information item is also searched. In such a case, the links linking together individual data items with journal data items are used.

According to a second embodiment of the tracing aspect, the tracing is performed by entering one or more search words, or strings, in order to search and find individual units upon which one or more specific processes, or events, have been performed. Such a search is primarily performed among the journal data items. However, in an alternative embodiment the individual unit information item is also searched. In such a case, the links linking together individual data items with journal data items are used.

These two embodiments provides the advantage that it is possible to trace specific individual units, what events they have been subjected to, and when.

### BRIEF DESCRIPTION OF THE DRAWING FIGURES

The invention will now be further described with reference to the following drawings. The foregoing and additional features and characteristics of the present invention will become more apparent from the following detailed description considered with reference to the accompanying drawing figures in which like reference numerals designate like elements.

FIG. 1 schematically illustrates an exemplary embodiment of an information item database comprising information items in accordance with the present invention.

FIG. 2 schematically illustrates the structure of an individual unit data item in accordance with the exemplary embodiments of the present invention.

FIG. 3 schematically illustrates the structure of a journal data item in accordance with the exemplary embodiments of the present invention.

FIG. 4 schematically illustrates a device incorporating an information item database in accordance with the exemplary embodiments of the present invention.

FIG. 5a illustrates a computer interface including an “Existing Bearing” section and an “Adding New bearing” section in accordance with the exemplary embodiments of the present invention.

FIG. 5b illustrates a computer interface including an “Adding New bearing” section in accordance with the exemplary embodiments of the present invention.

FIG. 5c illustrates a computer interface presenting both individual unit data items and journal data items in accordance with the exemplary embodiments of the present invention.

FIG. 5d illustrates a computer interface of the viewing and/or inputting of journal data items in accordance with the exemplary embodiments of the present invention.

FIG. 5e illustrates an application in accordance with the exemplary embodiments of the present invention.

FIG. 5f illustrates a computer interface including an “Existing Bearing” section, an “Adding New bearing” section and two individual unit data items in accordance with the exemplary embodiments of the present invention.

FIG. 6 schematically illustrates an embodiment of a client communication device in accordance with the present invention.

FIG. 7 schematically illustrates a system for processing information items in accordance with the exemplary embodiments of the present invention.

### DETAILED DESCRIPTION OF THE PREFERRED EMBODIMENTS

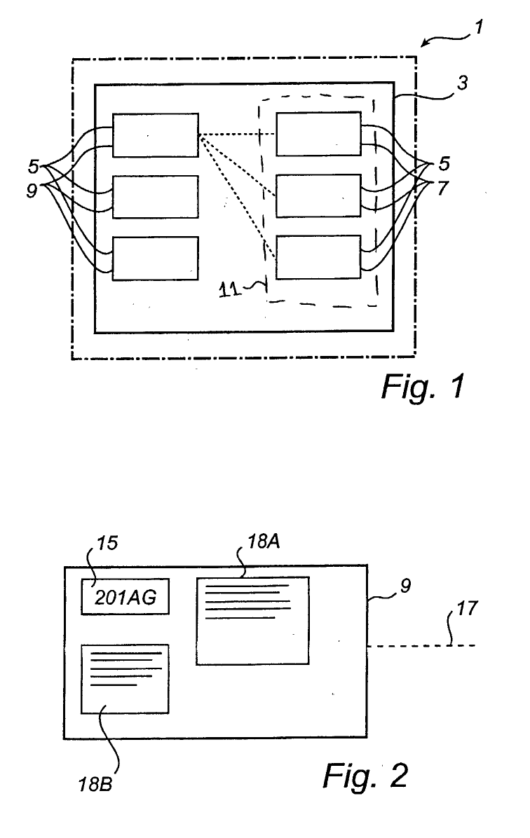

FIG. 1 illustrates an exemplary embodiment of the memory 1. Memory 1 comprises an information item database 3 comprising information items 5. In the information item database 3, each information item 5 is one of a journal data 7 item and an individual unit data item 9. In one exemplary embodiment the journal data items 7 are arranged in a journal data item portion 11 of the information item database 3.

Turning now to FIG. 2, each individual unit data item 9 comprises an individual unit identity 15 of an individual unit, at least one of text and image, and at least one link 17 linking at least one journal data item related to the individual data item to the individual data item. In this embodiment the contents of the individual unit data item 9 is text, including figures/numbers. In another exemplary embodiment, an image of an individual unit is used as an individual indicator. The individual unit data item 9 further comprises at least one of actual dimensions 18A, clearance, lubrication type, type of cage, preferred sealing, and the measuring protocol of the individual unit. The individual data item also comprises information 18B concerning at least one of manufacturing, testing, distributing, mounting, using, servicing, maintaining, and dismounting the individual unit.

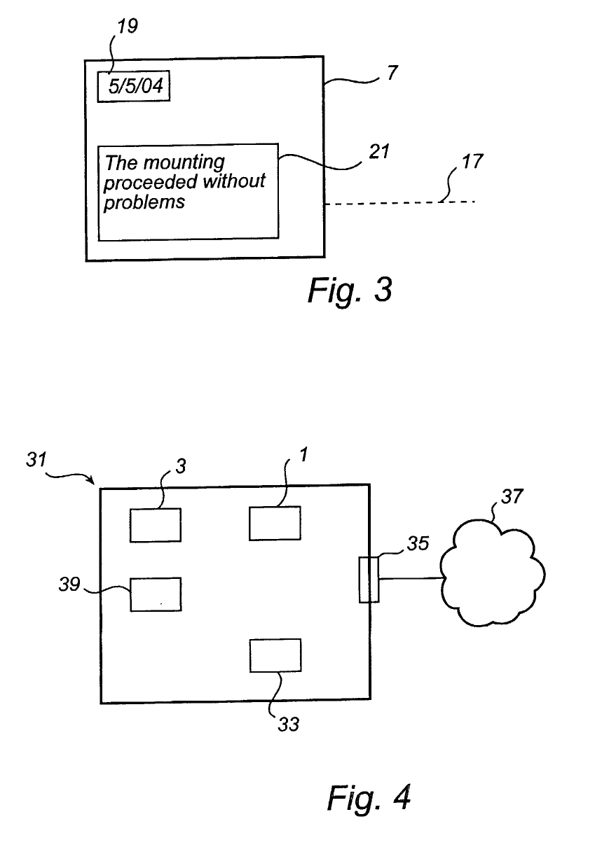

In another exemplary embodiment, illustrated in FIG. 3, the journal data items 7 are related to at least one point of time 19 in relation to at least one of the processes of manufacturing, testing, distributing, mounting, using, servicing, maintaining, and dismounting the individual unit. It should be noted that inputting point of time is not mandatory. For instance, in the manufacturing process of an individual unit the points of time may not be inputted. However, inputting points of time offers the advantage of being able to show information concerning at what time a specific process was undertaken in relation to an individual item. The process data 21 shown in FIG. 3 is a mounting procedure. Further, each journal data item 7 comprises at least one of text, image, symbol and binary data. For instance, binary data can include vibration data that was assembled at one date but is analysed at later occasions.

In one embodiment, illustrated in FIG. 4, the information item database 3 is incorporated in a device 31 for processing information items 5 related to one of an individual unit and an application of an individual unit. The individual unit is one of a bearing, a seal, and a product including one of a bearing and a seal. The device 31 comprises a processor 33, a memory 1, and an input/output connection 35. In one embodiment, the input/output connection 35 is connectable to the Internet 37.

The processor 33 receives at least one information item 5 from a user using the input/output connection 35. If the information item 5 is a journal data item 7, the processor 33 also receives a link 17 to the individual unit data item 9 in the information item database 3 related to the journal data item 7. The processor 33 also stores the at least one information item 5 in the information item database 3. If the information item is a journal data item 7, the processor 33 links it to the individual unit data item 9 according to the link 17. The processor receives at least one request from the user requesting an information item 5. The processor 33 retrieves the at least one requested information item 5 from the information item database 3 of the memory 1, and transmits the at least one requested information item 5 to the user using the input/output connection 35.

In one exemplary embodiment, the device 31 also comprises presentation means 39 to present information items 5 for a service provider. In another exemplary embodiment, each journal data item 7 is provided with a link 17 linking the journal data item 7 to an individual data item 9. In another exemplary embodiment, the input/output connection 35 is connectable to at least one of a movable media and an input/output means, such as a floppy disk station, of a computer for facilitating utility in relation to various means of receiving data.

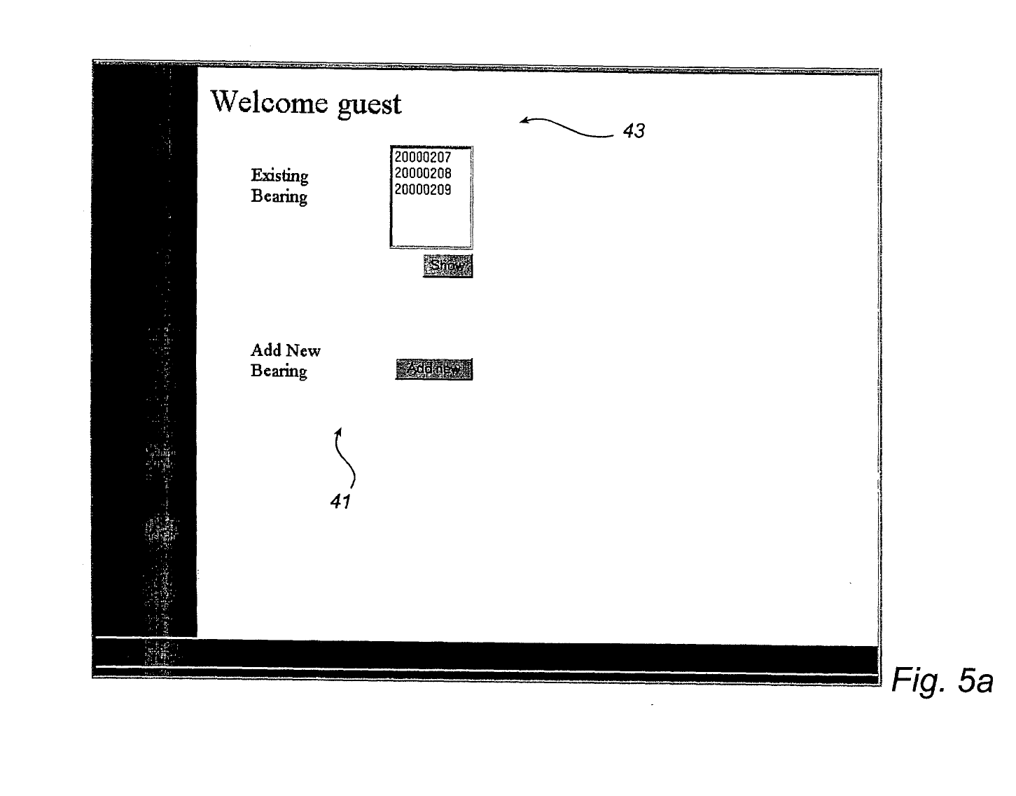

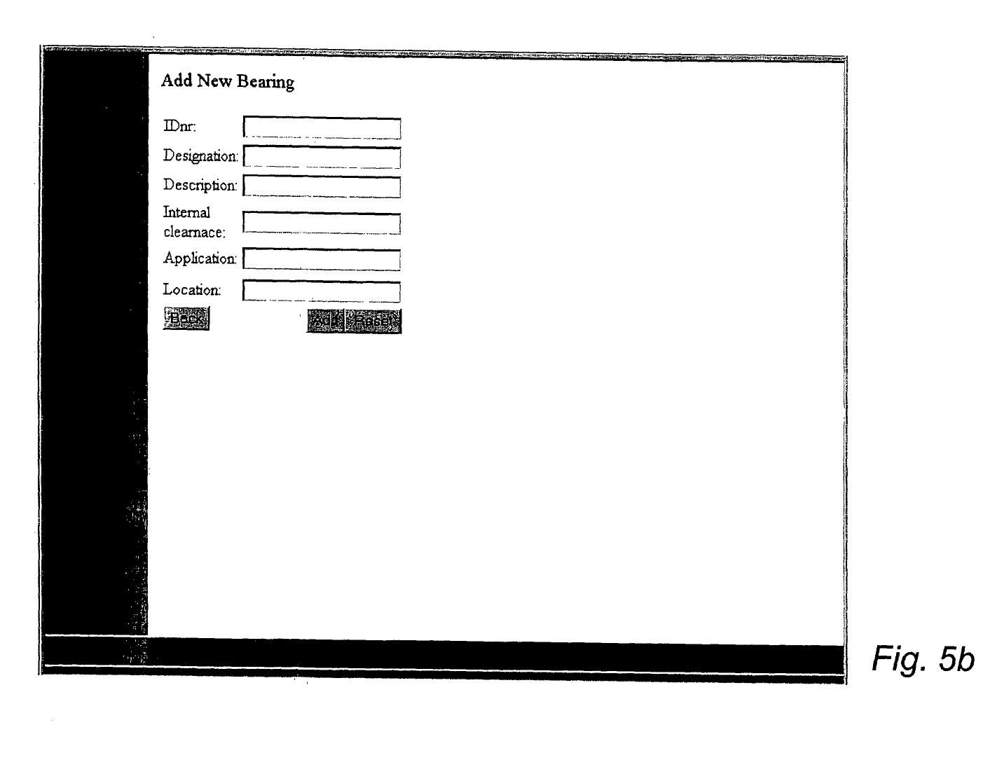

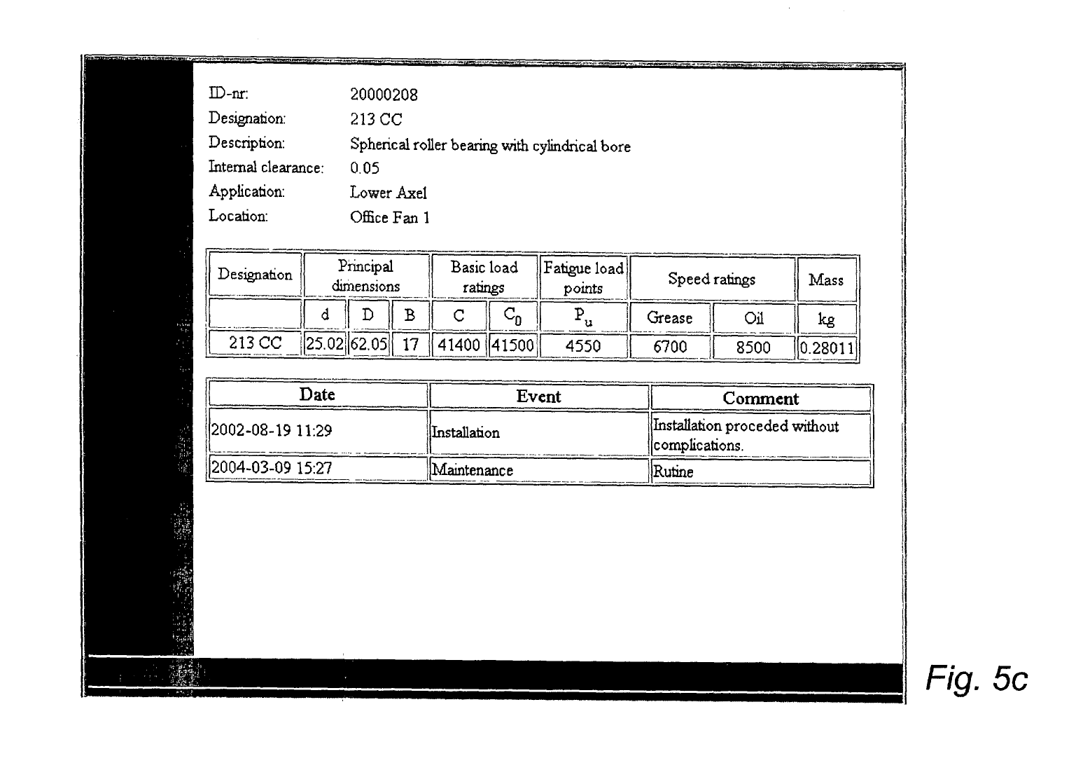

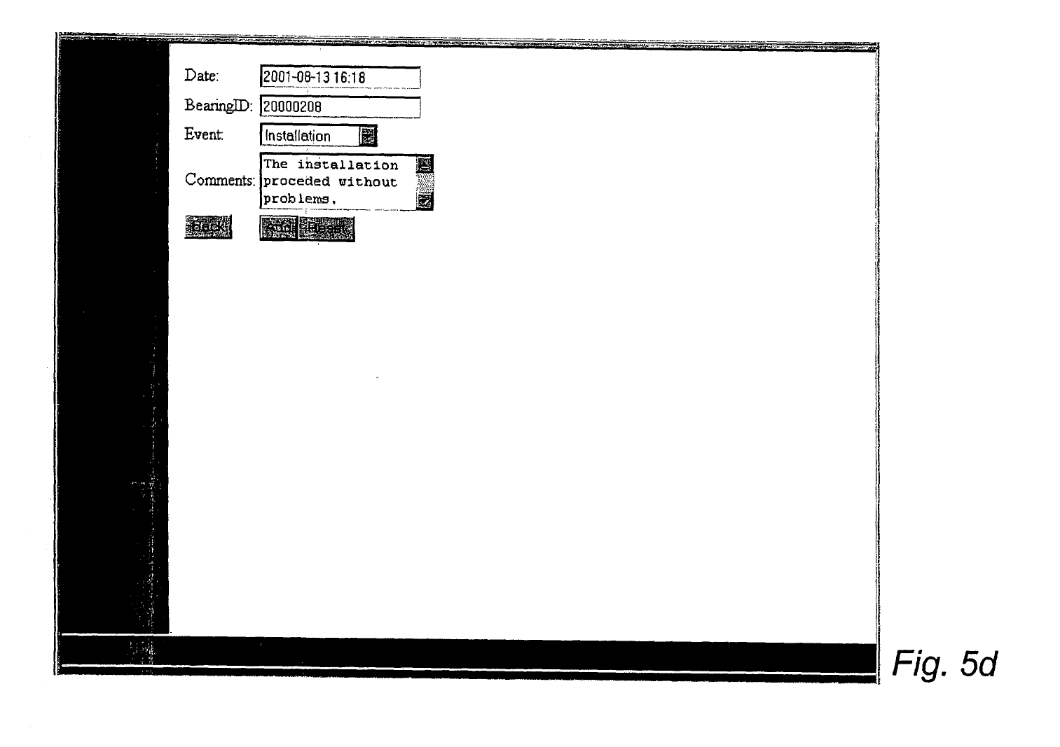

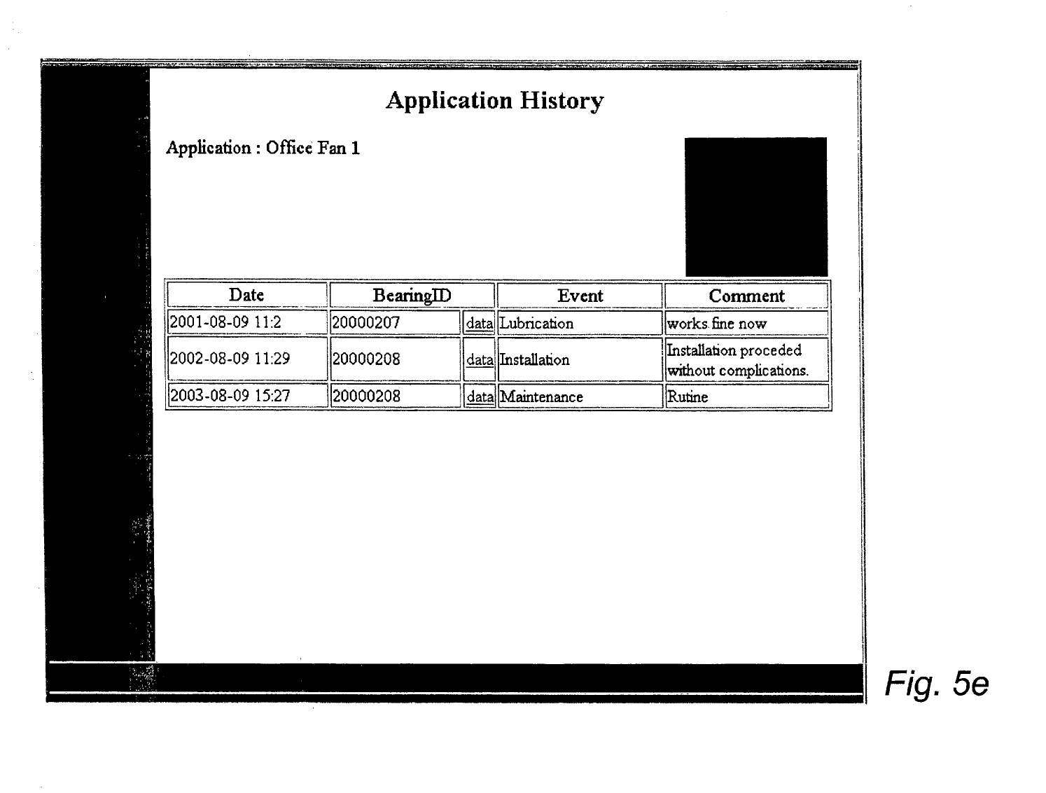

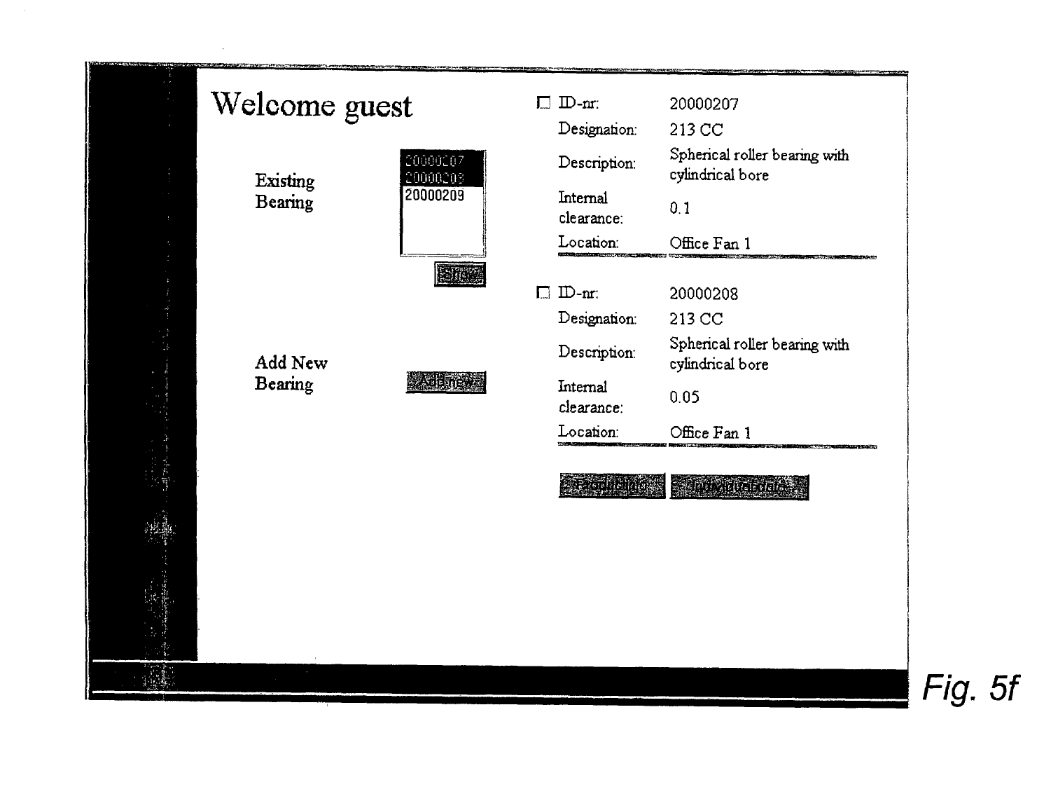

In another embodiment, in the form of a computer interface illustrated in FIG. 5a, the processor 33 can create new information items 3. In FIG. 5a this is exemplified by an “Adding New bearing” section 41. The individual units and applications that are present in the information item database 3 can be presented via the computer interface. In FIG. 5a, this is exemplified by the “Existing bearing” section 43.

FIG. 5b illustrates a computer interface of information to be inputted in the case of “Adding new bearing” setting. This also exemplifies the contents of the individual unit data item.

FIG. 5c illustrates shows a computer interface presenting both individual unit data items (in the upper part of the interface) and journal data items (in the lower part of the interface under “Date”, “Event”, and “Comment”).

An alternative computer interface of the viewing and/or inputting of journal data items is presented in FIG. 5d. By clicking on the “Add” button further information can be inserted.

A computer interface presenting data in relation to an application is presented in FIG. 5e. The application presented in FIG. 5e is an “Office Fan 1” and it is provided with at least two individual units, in this case two bearings. In this embodiment an image of the fan can be presented in black box in the upper right corner of the interface. As in the computer interface presented in FIG. 5c, the interface shows information concerning “Date”, “Event”, and “Comment”. However, in this embodiment the user is offered the possibility to obtain further data by pressing the “data” button located in the “Bearing ID” column. The data is here related to at least one individual unit data item.

FIG. 5f shows a computer interface generated by the device 31 and to be displayed on the presentation means 39 or at the location of a client communication device 51, which will be further described below. In FIG. 5f two existing bearings (with identities 20000207 and 20000208, respectively) have been marked, and further information is presented to the right of the two marked bearing.

In another exemplary embodiment, the processor 33 is arranged to delete information items 5 according to a request of a user or a service provider.

In another exemplary embodiment of the device, the information items 5 are configured with access levels, and the processor 33 verifies a user in relation to the access levels. An example of the access of a user and a service provider in relation to activities are presented in the following table.

| Activity | User | Service provider |
|---|---|---|
| Create a new information item | Yes | Yes |
| Delete an information item | No | Yes |
| Add information to an | Yes | Yes |
| information item | | |
| Change information of an | No | Yes |
| information item | | |
| Remove information of an | No | Yes |
| information item | | |

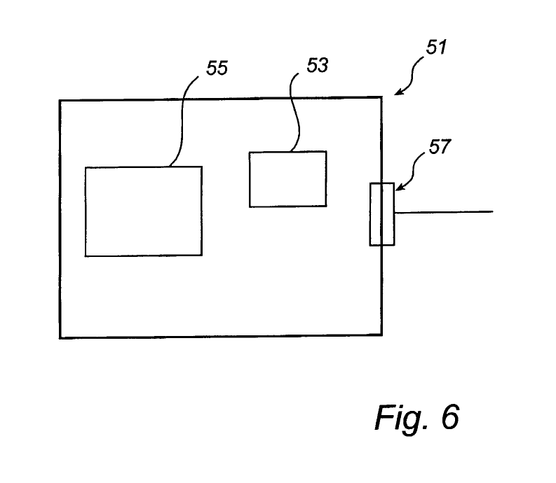

FIG. 6 illustrates an exemplary embodiment of a client communication device. The client communication device is arranged for communicating information items 5 in relation to the device 31 for processing information items 5. The information items 5 are related to one of an individual unit and an application of an individual unit. The individual unit is one of a bearing, a seal, and a product including one of a bearing and a seal. The client communication device 51 comprises a processor 53, a memory 55, and an input/output connection 57.

In another exemplary embodiment the client communication device is a handheld computer arranged to communicate via one of wired and wireless manners. In another exemplary embodiment the client communication device is a personal computer.

The structure and function of the information items 5 in relation to the client communication device 51 are the same as described in the embodiment of the device 31 above.

The processor 53 adds information to at least one information item 5. Using the input/output connection 57, the processor 53 transmits at least one information item 5 from a user to the device 31 for processing information items 5. If the information item 5 is a journal data item 7, the processor 53 also transmits a link 17 to the individual unit data item 9 related to the journal data item 7. The processor 53 transmits at least one request from the user requesting an information item 5 and receives the at least one requested information item 5 from the device 31 for processing information items 5.

The structure and function of the journal data items 7 in relation to the client communication device 51 are the same as described in the embodiment of the device 31 above. The structure and function of the individual unit data items 9 in relation to the client communication device 51 being the same as described in the embodiment of the device 31 above. In one embodiment of the client communication device 51, the processor 53 is further configured for creating new individual unit data items.

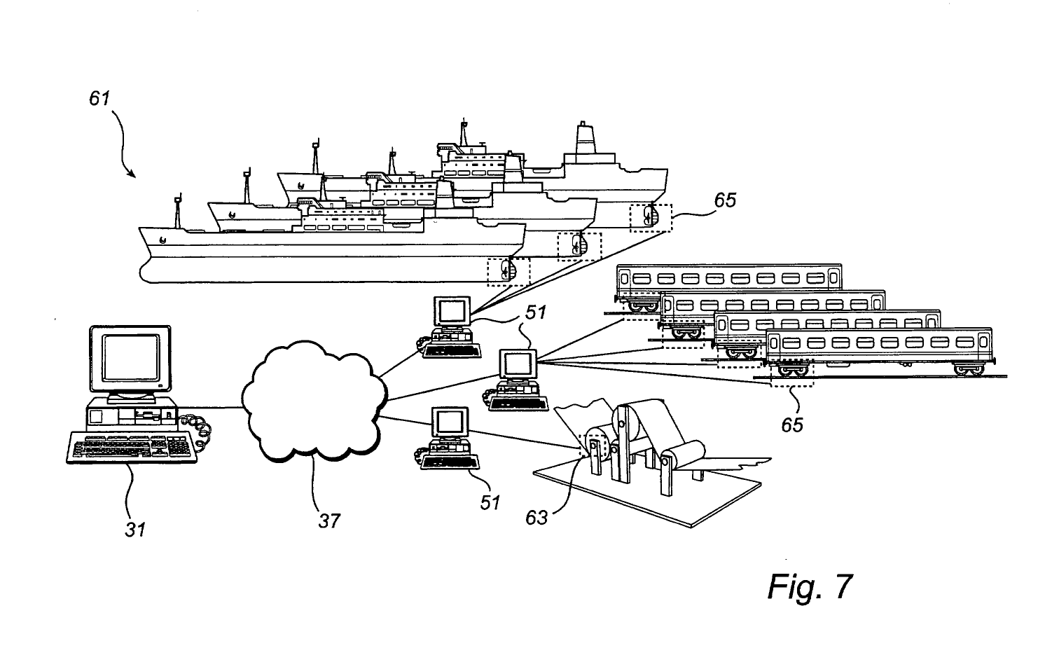

FIG. 7 illustrates a system 61 comprising a device 31 and a client communication device 51. The system 61 processes information items 5 related to at least one individual unit 63, the individual unit being one of a bearing, a seal, and a product 65 including one of a bearing and a seal. Specifically, FIG. 7 illustrates several exemplary applications of individual units. For example, FIG. 7 illustrates a bearing supporting the camshaft of a boat in the application of the camshaft of a boat. FIG. 7 also illustrates a bearing used in paper manufacturing in the application of bearing receiving section in paper manufacturing. FIG. 7 further illustrates a train bearing unit potentially comprising more than a single bearing used in a train or a tram in the application of a train bearing unit receiving section of a train or a tram.

Thus, it is clear that there are relations between an individual unit and its application. Keeping track of the application provides an opportunity of knowing what individual units that have been applied in a specific application. It should be recognized that the application of the present invention goes beyond the three applications discussed above.

According to another preferred embodiment, a computer program product processes information items related to one of an individual unit and an application of an individual unit. The computer program product is loadable into the internal memory of a computer, comprising software code portions for performing the steps discussed above in relation to the device 31, when run on the computer. Due to the great resemblance to the computer software incorporated information item database 3 and the device 31 it will not be elaborated further.

According to another preferred embodiment, a data repository processes information items related to one of an individual unit and an application of an individual unit. The data repository is loaded into the memory 1 of the device 31. Due to the great resemblance to the computer software incorporated information item database 3 and the device 31 it will not be elaborated further.

According to another exemplary embodiment the device 31 is used to trace individual units based on searching the information item database 3 comprising the information items 5. Tracing is performed to determine the cause of poor quality in relation to processes of manufacturing. A trace can provide important information when it comes to finding explanations to unexpected malfunctions. Thus, a tracing facility provides an instrument of the quality work of the manufacturing. Tracing can explain causes of extraordinary events, such as malfunctions.

According to a first embodiment of the tracing aspect, the tracing is performed by entering one or more individual unit data items 9 resulting in one or more traces. In the information item database 3, this is achieved by searching, based on search string methodology, for one or more individual unit identities 15 among the individual unit data items 9 to find what events that may have caused an extraordinary effect on one or more individual units. However, in an alternative embodiment the individual unit information item 9 is also searched. In such a case, the links 17 linking together individual unit data items 9 with journal data items 7 are used.

According to a second embodiment of the tracing aspect, the tracing is performed by entering one or more search words, or strings, in order to search and find individual units upon which one or more specific processes, or events, have been performed. Such a search is primarily performed among the journal data items. However, in an alternative embodiment the individual unit information item is also searched. In such a case, the links linking together individual data items with journal data items are used.

The principles, preferred embodiments and modes of operation of the present invention have been described in the foregoing specification. However, the invention which is intended to be protected is not to be construed as limited to the particular embodiments disclosed. Further, the embodiments described herein are to be regarded as illustrative rather than restrictive. Variations and changes may be made by others, and equivalents employed, without departing from the spirit of the present invention. Accordingly, it is expressly intended that all such variations, changes and equivalents which fall within the spirit and scope of the present invention as defined in the claims, be embraced thereby.

What is claimed is:

1. A device for processing information items comprising:
an input/output connection;
a memory comprising an information item database, the information item database comprising information items, each information item being one of a journal data item and an individual unit data item, each individual unit data item comprising an individual unit identity of an individual unit, at least one of text and image, and at least one link linking at least one journal data item related to the individual unit data item to the individual unit data item, wherein each journal data item comprises at least one of text, image, symbol and binary data;
a processor which receives at least one information item from the input/output connection, wherein if the information item is a journal data item, the processor also receives a link to the individual unit data item in the information item database related to the journal data item, the processor stores the at least one information item in the information item database, wherein if the information item is a journal data item, the processor links the journal data item to the individual unit data item according to the link, the processor receives at least one request from the user requesting an information item, the processor retrieves from the information item database of the memory and transmits the at least one requested information item using the input/output connection.

2. A device according to claim 1, wherein the journal data items are related to at least one point of time in relation to at least one of the processes of manufacturing, testing, distributing, mounting, using, servicing, maintaining, and dismounting the individual unit.

3. A device according to claim 1, wherein the individual unit data item further comprises at least one of actual dimensions, clearance, lubrication type, type of cage, preferred sealing, and the measuring protocol of the individual unit and, information concerning at least one of manufacturing, testing, distributing, mounting, using, servicing, maintaining, and dismounting the individual unit.

4. A device according to claim 1, wherein each journal data item is provided with a link linking the journal data item to an individual data item.

5. A device according to claim 1, wherein the input/output connection is connectable to at least one of a data communication network, a movable media, and an input/output means of a computer.

6. A device according to claim 1, wherein the processor creates new information items.

7. A device according to claim 1, wherein the processor deletes information items.

8. A device according to claim 1, wherein the information items are configured with access levels and the processor verifies a user in relation to the access levels.

9. A client communication device for communicating information items in relation to a device for processing information items, the information items being related to one of an individual unit and an application of an individual unit, the individual unit being one of a bearing, a seal, and a product including one of a bearing and a seal, the client communication device comprising:
a memory;
an input/output connection; and
a processor which adds information to at least one information item using the input/output connection, transmits at least one information item from the input/output connection to the device for processing information items, and if the information item is a journal data item, then a link is also transmitted to the individual unit data item related to the journal data item, the processor transmits at least one request from the user requesting an information item, and the processor receives the at least one requested information item from the device for processing information items,
wherein each information item is one of journal data item and individual unit data item, each individual unit data item comprises an individual unit identity of an individual unit, at least one of text and image, and at least one link linking at least one journal data item related to the individual unit data item to the individual data item, and wherein each journal data item comprises at least one of text, image, symbol and binary data.

10. A client communication device according to claim 9, wherein the journal data items are related to at least one point of time in relation to at least one of the processes of manufacturing, testing, distributing, mounting, using, servicing, maintaining, and dismounting the individual unit.

11. A client device according to claim 9, wherein each journal data item is provided with a link linking the journal data item to an individual data item.

12. A client device according to claim 9, wherein the individual unit data item further comprises at least one of actual dimensions, clearance, lubrication type, type of cage, preferred sealing, the measuring protocol of the individual unit, and information concerning at least one of manufacturing, testing, distributing, mounting, using, servicing, maintaining, and dismounting the individual unit.

13. A client device according to claim 9, wherein the processor creates new individual unit data items.

14. System for processing information items related to at least one individual unit, the individual unit being one of a bearing, a seal, and a product including one of a bearing and a seal, the system comprising:
a device, the device comprising
an input/output connection;
a memory comprising an information item database, the information item database comprising information items, each information item being one of a journal data item and an individual unit data item, each individual unit data item comprising an individual unit identity of an individual unit, at least one of text and image, and at least one link linking at least one journal data item related to the individual unit data item to the individual unit data item, wherein each journal data item comprises at least one of text, image, symbol and binary data;
a processor which receives at least one information item from the input/output connection, wherein if the information item is a journal data item, the processor also receives a link to the individual unit data item in the information item database related to the journal data item, the processor stores the at least one information item in the information item database, wherein if the information item is a journal data item, the processor links the journal data item to the individual unit data item according to the link, the processor receives at least one request from the user requesting an information item, the processor retrieves from the information item database of the memory and transmits the at least one requested information item using the input/output connection; and
a client device, the client communication device comprising
a memory;
an input/output connection; and
a processor which adds information to at least one information item using the input/output connection, transmits at least one information item from the input/output connection to the device for processing information items, and if the information item is a journal data item, then a link is also transmitted to the individual unit data item related to the journal data item, the processor transmits at least one request from the user requesting an information item, and the processor receives the at least one requested information item from the device for processing information items.

15. Computer program product for processing information items related to one of an individual unit and an application of an individual unit, the individual unit being one of a bearing, a seal, and a product including one of a bearing and a seal, wherein each information item is one of journal data item and individual unit data item, each individual unit data item comprising an individual unit identity of an individual unit, at least one of text and image, and at least one link linking at least one journal data item related to the individual unit data item to the individual unit data item, and wherein each journal data item comprises at least one of text, image, symbol and binary data, the computer program product being loadable into the internal memory of a computer, comprising software code portions for performing the steps of:
receiving at least one information item from the input/output connection;
receiving a link to the individual unit data item in the information item database related to the journal data item if the information item is a journal data item;
storing the at least one information item in the information item database;
linking the journal data item to the individual unit data item according to the link if the information item is a journal data item;
receiving at least one request from the user requesting an information item; and
retrieving from the information item database of the memory and transmitting the at least one requested information item using the input/output connection.

16. Computer program product according to claim 15, wherein the journal data items are related to at least one point of time in relation to at least one of the processes of manufacturing, testing, distributing, mounting, using, servicing, maintaining, and dismounting the individual unit.

17. Computer program product according to claim 15, wherein the individual unit data item further comprises at least one of actual dimensions, clearance, lubrication type, type of cage, preferred sealing, and the measuring protocol of the individual unit and, information concerning at least one of manufacturing, testing, distributing, mounting, using, servicing, maintaining, and dismounting the individual unit.

18. Computer program product according to claim 15, wherein each journal data item is provided with a link linking the journal data item to an individual data item.

19. A method for processing information items related to one of an individual unit and an application of an individual unit, the individual unit being one of a bearing, a seal, and a product including one of a bearing and a seal, comprising:
storing, in a data repository, an information item database comprising information items of which each information item being one of journal data item and individual unit data item, each individual unit data item comprising an individual unit identity of an individual unit, at least one of text and image, and
generating at least one link linking at least one journal data item related to the individual unit data item to the individual unit data item, each journal data item comprising at least one of text, image, symbol and binary data.

20. A method according to claim 19, wherein the journal data items are related to at least one point of time in relation to at least one of the processes of manufacturing, testing, distributing, mounting, using, servicing, maintaining, and dismounting the individual unit.

21. A method according to claim 19 wherein the data repository is incorporated in a memory.

22. A method for processing information items comprising:
storing an information item database in a memory, the information item database comprising information items, each information item being one of a journal data item and an individual unit data item, each individual unit data item comprising an individual unit identity of an individual unit, at least one of text and image, at least one link linking at least one journal data item related to the individual unit data item to the individual unit data item, each journal data item comprising at least one of text, image, symbol and binary data;
receiving, by a processor, at least one information item from an input/output connection;
receiving, if the information item is a journal data item, a link to the individual unit data item in the information item database related to the journal data item;
storing, by the processor, the at least one information item in the information item database;
linking, if the information item is a journal data item, the journal data item to the individual unit data item according to the link;
receiving, by the processor, at least one request from the user requesting an information item;
retrieving by the processor from the information item database of the memory the at least one requested information item; and
transmitting the at least one requested information item using the input/output connection.

23. A method according to claim 22, wherein the journal data items are related to at least one point of time in relation to at least one of the processes of manufacturing, testing, distributing, mounting, using, servicing, maintaining, and dismounting the individual unit.

24. A method according to claim 22, wherein the individual unit data item further comprises at least one of actual dimensions, clearance, lubrication type, type of cage, preferred sealing, and the measuring protocol of the individual unit and, information concerning at least one of manufacturing, testing, distributing, mounting, using, servicing, maintaining, and dismounting the individual unit.

25. A method according to claim 22, wherein each journal data item is provided with a link linking the journal data item to an individual data item.

26. A method according to claim 22, further comprising:
tracing individual units to determine a cause of a malfunction of the individual units.

27. A method according to claim 26, wherein the step of tracing further comprises:
searching the information item database; and
presenting journal data items associated with the individual units.
